(19) United States
(12) Patent Application Publication
(10) Pub. No.: US 2002/0103727 A1
(43) Pub. Date: Aug. 1, 2002

(54) Data management system

(76) Inventors: Robert J. Tait, Birch Grove (AU); Dimitry O. Gurieff, Bella Vista (AU)

Correspondence Address: Gottlieb, Rackman & Reisman, P.C., 270 Madison Avenue, New York, NY, 10016-0601, US

(21) Appl. No.: 09/965,025

(22) Filed: Sep. 27, 2001

(30) Foreign Application Priority Data
Sep. 27, 2000 (AU) PR0401

(51) Int. Cl. G06F 17/60

(52) U.S. Cl. 705/28

(57) ABSTRACT

A data management system for cataloguing product components and their compatibility with various products includes a processor, a database containing component and product data, and multiple supplier interfaces receiving product identifiers from a central administrator, creating component groups, assigning the product identifiers to compatibility groups within those component groups, and creating associations between components and the compatibility groups.

This application claims the Sep. 27, 2000 priority filing date of Australian Provisional Application No. PR0401.

### BACKGROUND OF THE INVENTION

This invention relates to a system for establishing and maintaining a product to application database in a convenient and searchable form. The invention will be described with particular application to the automotive industry but it is not intended to be limited thereto.

In the product component and spare parts industries there may be many suppliers that manufacture and supply similar parts and components. Each supplier will typically publish a catalogue of the products they manufacture that correlates their components with the products on which they can be used. For example a manufacturer of oil filters for motor vehicles will publish a catalogue of the types of oil filters they manufacture that also lists the different makes and models of vehicles for which specific oil filters are suitable. These catalogues are typically provided in printed or electronic form to a parts and components distributor who may sell a range of parts and components from a plurality of manufacturers. The distributor therefore requires multiple catalogues in order to properly handle customer enquiries and purchase orders. These catalogues are clumsy for the distributor to handle and require constant updating and incorporation into the distributor's own systems. This process needs to be replicated across many distributors and suppliers, thus considerable time and expense is wasted.

In addition, the component suppliers will list compatibility of their components with products using different product descriptors. Therefore, interpretative skill is required in using the catalogues of the multiple suppliers, and the information provided by the suppliers is not in readily computer-searchable form.

### SUMMARY OF THE INVENTION

In one form, the present invention provides, in a computer database adapted for use by a product component supplier, a method of cataloguing components provided by said supplier and compatibility of said components with a plurality of products, including the steps of:

creating and modifying data relating to components specific to that supplier, said data including component identifiers for said components provided by said supplier,

creating and modifying a plurality of component groups, each component group containing component identifiers for one or more of said supplier's components of similar type,

creating and modifying one or more compatibility groups independently within each said components group,

creating and modifying associations between component identifiers and compatibility groups,

receiving product identifiers created by an external source and assigning each product identifier to a compatibility group within each component group, such that each compatibility group includes one or more product identifiers representing products with similar compatibilities within the respective components groups, and

providing a search tool whereby said database is queried by product identifier and component group to return one or more component identifiers compatible with the product represented by the product identifier.

Preferably, the step of assigning a product to a compatibility group comprises assigning the product to an existing compatibility group, assigning the product to a new compatibility group or assigning the product to an unassigned compatibility group.

In a further form, the invention provides in a computer database adapted for use by an administrator and multiple product component suppliers, a method of cataloguing components provided by said multiple suppliers and compatibility of said components with a plurality of products, including the steps of:

providing each said supplier with access to a portion of data relating to components specific to that supplier, said data including component identifiers for said components provided by said supplier,

providing each said supplier with tools for creating and modifying a plurality of component groups, each component group containing component identifiers for one or more of said suppliers components of similar type,

creating product identifiers relating to products, and exporting said created product identifiers to said multiple suppliers,

providing each said supplier with tools for creating and modifying one or more compatibility groups independently within each said components group and for creating and modifying associations between component identifiers and compatibility groups,

said suppliers receiving said exported product identifiers and assigning each product to a compatibility group within each component group, such that each compatibility group includes one or more product identifiers representing products with similar compatibilities within the respective components groups, said suppliers exporting said data portion as modified to said administrator,

consolidating said data portions received from said suppliers into said database, and

providing a search tool whereby said database is queried by product identifier and component group to return one or more component identifiers compatible with the product represented by the product identifier.

In a yet further form, the invention resides in a database system for cataloguing components provided by a product component supplier and compatibility of said components with a plurality of products, including:

a computer processor,

a database readable by said processor,

component and product data stored in said database, said data including a plurality of component identifiers divided into one or more component groups,

each component group including one or more compatibility groups containing product identifiers, and associations between said component identifiers and a compatibility group, and

a search tool queried by component identifier to return one or more product identifiers compatible with the component represented by the component identifier.

Preferably, the component data includes data relating to components from multiple component suppliers.

Preferably also, the database system further includes multiple supplier interfaces each allowing access to a part of the data relating to the components of the respective supplier, said supplier interfaces including tools for creating and modifying one or more compatibility groups independently within each said components group, for creating and modifying associations between component identifiers and compatibility groups, and for receiving exported product identifiers and assigning each product to a compatibility group within each component group, such that each compatibility group includes one or more product identifiers representing products with similar compatibilities within the respective components groups,

Preferably, each component identifier is assigned to only one compatibility group in respect of a component group.

Preferably, the system includes means for updating the database to include new product identifiers within a component group by one of assigning the product identifier to an existing compatibility group, creating a new compatibility group for said product identifier or assigning said new product identifier to an unassigned group, said unassigned group containing no association to a component within the component group.

It will be understood that the term “components”, as used herein, incorporates reference not only to replacement parts for a product, but also to accessories adapted for use with a product.

### BRIEF DESCRIPTION OF THE DRAWINGS

The invention will now be described by way of example only with specific reference to the system as it applies to the automotive industry, though it will be readily apparent to the skilled reader that other applications within the scope of the invention are possible. The system will further be described with reference to the accompanying Figures in which:

FIG. 1 shows schematically the system of the present invention, and

FIG. 2 is a part screen of a supplier interface, showing assignment of new product identifiers to compatibility groups within the same vehicle make;

FIG. 3 is a part screen of a supplier interface, showing assignment of new product identifiers to compatibility groups across vehicle makes; and

FIG. 4 is a part screen of the supplier interface, showing association of a component to a compatibility group.

### DETAILED DESCRIPTION OF THE INVENTION

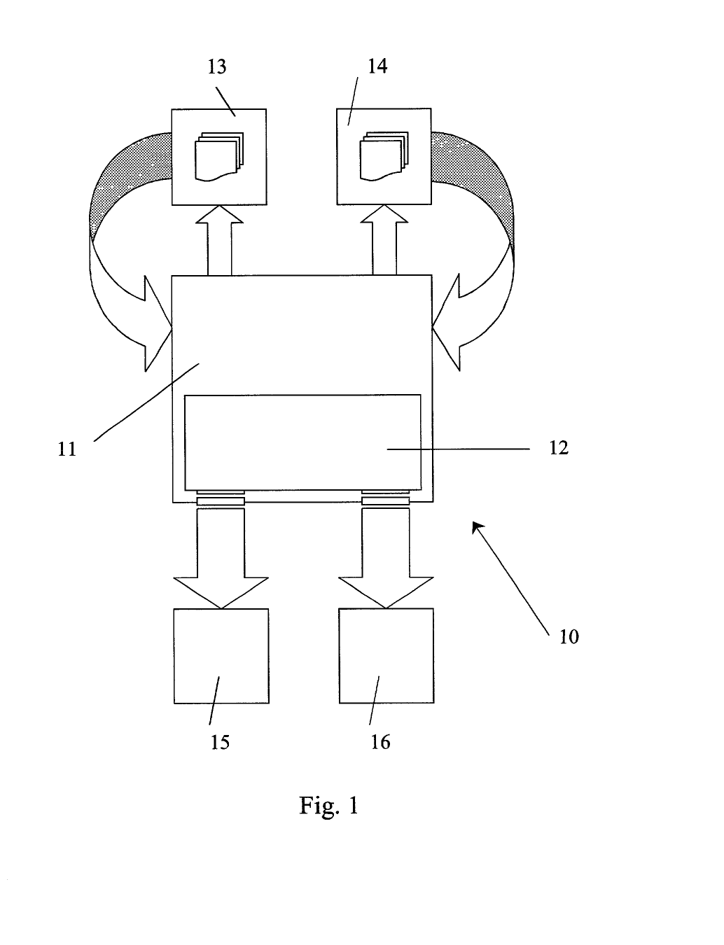

Shown in FIG. 1 is the system according to the invention as denoted generally by reference numeral 10. The system 10 includes at its center a computer interface 11 that provides a link between a core database 12 and a plurality of component supplier interfaces 13, 14. The links between the center computer 11 and the supplier interfaces 13, 14, may be hardwired links forming part of a local area network but are preferably telecommunications links forming part of a wide area network such as the Internet. Alternatively, the transfer of information between the central computer and the suppliers may be on compact disk or other computer media.

The central computer 10 is operated by a host administrator. The supplier interfaces 13, 14 are operated by product component suppliers who in the present example manufacture and/or supply spare parts to the automotive industry.

The database 12 stores information on the different parts supplied by the suppliers and associations between those parts and the different motor vehicles with which those parts are compatible.

The component information and associations are provided by the suppliers. To establish the database, a supplier creates an electronic catalogue of all the components manufactured by the supplier. Typically a supplier will manufacture components in one or more component groups but with a variety of components within each group that are compatible with specific models of motor vehicle. For example a supplier may provide oil filters and head gaskets to the spare parts market, but different filters and gaskets will be required for different vehicles thus requiring the supplier to provide a range of these components. The supplier will typically identify each different component they supply with a unique part number. Thus a catalogue of all the parts supplied by that supplier may be as appears in Table 1.

TABLE 1
Supplier X Catalogue

| Component Group | Part Number |
|---|---|
| Oil Filters | X-OF-1 |
| | X-OF-2 |
| | X-OF-3 |
| Head Gaskets | X-HG-1 |
| | X-HG-2 |
| | X-HG-2 |

The administrator has control over the creation and modification of product information, including assigning of product identifiers designating different motor vehicle types. It should be noted that in order to provide maximum flexibility to the system, and to aid in searching, these product identifiers are assigned preferably at a detailed level of specificity as to trim and options. These product identifiers are then exported to each supplier interface.

After creating the catalogue of supplier parts, the supplier then creates compatibility groups by making educated choices as to similarities between motor vehicles represented by the existing and newly received product identifiers, for the component group in question. For example, in regard to oil filters, a supplier may decide that motor vehicle MV-A is the same as motor vehicle MV-B and thus place them in the same compatibility group, yet in regard to head gaskets decide that vehicle MV-A and vehicle MV-B are different and thus place them in separate compatibility groups. A supplier's compatibility groupings may appear as in Table 2.

TABLE 2
Supplier X Compatibility Groups

| Component | Compatibility | Product |
|---|---|---|
| Group | Group | Identifiers |
| Oil Filters | X-CG-1 | MV-A, MV-B |
| | X-CG-2 | MV-C |
| Head Gaskets | X-CG-3 | MV-A |
| | X-CG-4 | MV-B, MC-C |

The compatibility groups can be created at the supplier interface using known “drag and drop” software tools by selecting specific motor vehicle product identifiers from a list and placing them in a compatibility group directory or folder, or vice versa.

Within a component group, each motor vehicle identity belongs to only one compatibility group, though that compatibility group may be associated with multiple components within that component group.

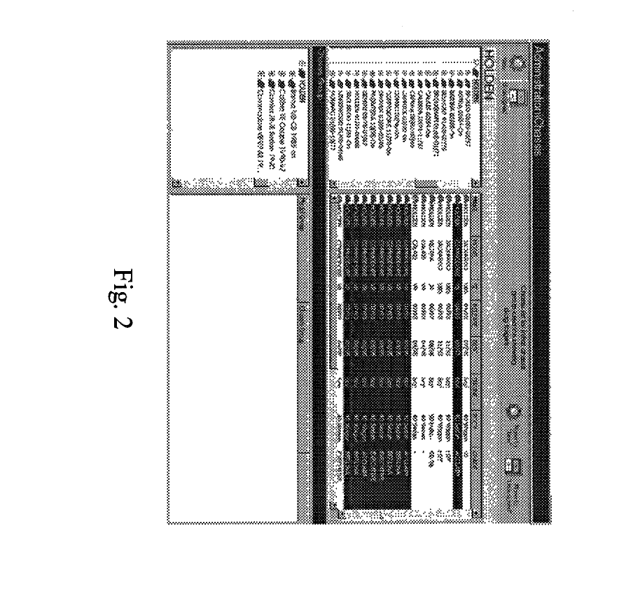

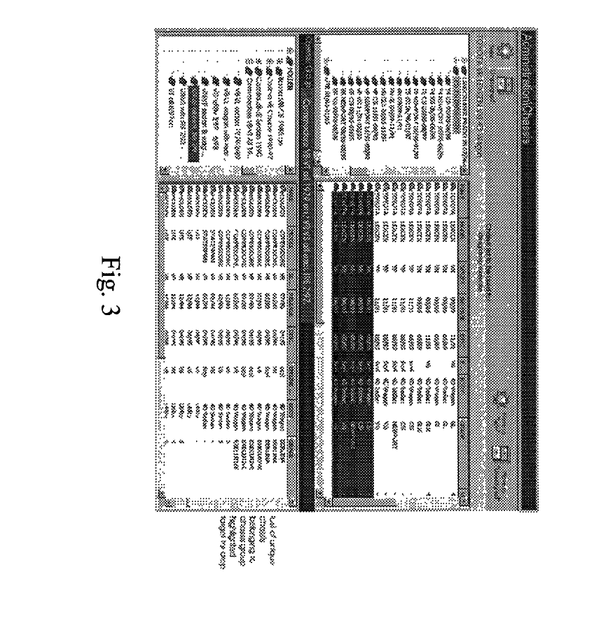

FIGS. 2 and 3 are examples of supplier interface screens for assigning product identifiers newly received by the supplier, after creation of these identifiers by the administrator and export to the supplier interfaces.

With reference to FIGS. 2 and 3, the part screen shown includes an upper and lower window, each in well-known representation with a hierarchical tree structure in the left side sub-window and the contents of the highlighted item of the hierarchy in the right side sub-window.

The top window includes the new product identifiers exported from the administrator to the supplier, arranged in hierarchy according to vehicle make and model, awaiting assignment to “chassis groups” (i.e. compatibility groups) by the supplier in respect of the component group being worked on at that time. As can be seen in the top right sub-window, the vehicle (product) identifier specifies each vehicle type in some detail, including make, model, series, release and discontinued dates, engine, body type, and grade, and also includes further details such as transmission type.

The bottom window contains the chassis groups created by the supplier in respect of the component group being worked on. This will be shown elsewhere on the screen, outside the part screen shown, and be selected by drop-down box or similar.

The chassis groups are again arranged in a hierarchy by vehicle make in the left side sub-window, with the vehicle identifiers assigned to the selected chassis group listed in the right side sub-window.

New vehicles in the top right sub-window can be assigned to an existing chassis group by highlighting the vehicle identifiers and dragging them onto an existing chassis group in the bottom window, or by dragging the chassis group onto the vehicle identifier. If the newly added vehicles do not fit the name of the existing chassis group, a modified name for the chassis group will be suggested, for acceptance or modification by the user.

To create a new chassis group within the same vehicle make, as shown in FIG. 2, vehicle identifiers of that make can be dragged onto the make name in the chassis group window. This will create a new chassis group within that make, and will suggest a name based on the selected vehicle identifiers. The suggested name can be accepted or modified by the user.

In FIG. 3, the vehicle identifiers selected in the top right sub-window are for “Toyota Lexcen” vehicles, which are identical in most respects to the “Holden Commodore”. Dragging the Toyota Lexcen vehicle identifiers onto the Holden Commodore chassis group will create convert that chassis group to a “Super”, or multi-make chassis group, thus taking into account the modem practices of “badge engineering” within the motor vehicle industry.

Vehicles for which the supplier does not components within that component group can be placed in an unassigned group. If subsequently the supplier does provide components for those vehicles, those vehicles can be transferred to new or existing chassis groups.

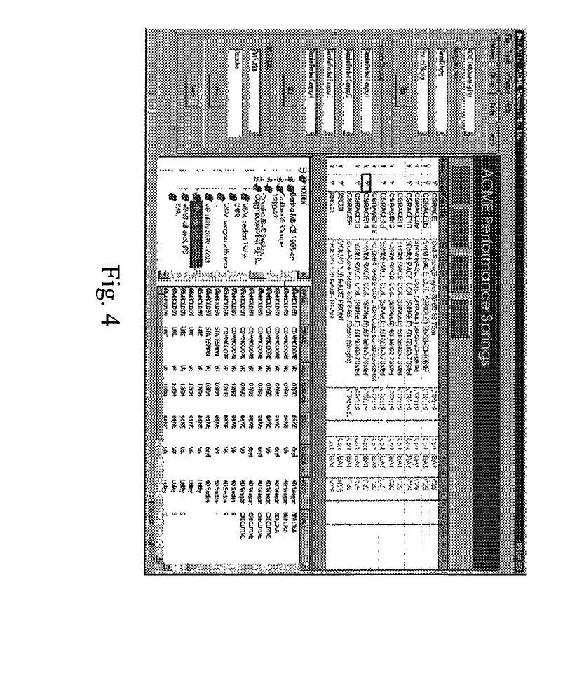

Once the catalogue and compatibility groups have been created, the supplier can then commence to associate specific components within a component group with the compatibility groups created for that component group. The associations can be created at an interface, for example the interface shown in FIG. 4, again using “drag and drop” tools by first opening a directory corresponding to a component group. When this directory is opened, a list of sub-directories pertaining to all components and to all compatibility groups for that component group is presented. To create an association, the supplier selects and opens a sub-directory for a specific component and drags a compatibility group into that sub-directory, or vice versa by dragging a component onto a compatibility group. The selected compatibility group will be the group containing all vehicles that are compatible with that specific component.

The screen in FIG. 4 has its bottom window similar to those of FIGS. 2 and 3, with chassis group and vehicle identifiers as described above. The top window lists details of the suppliers components within the component group specified. These details may be created within the present database system, or imported from a separate supplier database.

The components in the top window may be associated with the chassis groups below, by similar drag and drop procedures as described above with reference to FIGS. 2 and 3.

When the association from a specific component to a compatibility group is nominated by the supplier the system software automatically creates an association path from each member of the compatibility group to the specific component. In this way, the database becomes searchable so that a user can specify a vehicle identity and a component group identity and thereby determine the component within the nominated component group that is compatible with the nominated vehicle.

Once a supplier has established their electronic catalogue including all relevant associations, the catalogue can be used in-house by the supplier, storing all the information in a local database, updating and maintaining the database as required. However, in accordance with the preferred embodiment of the invention, the component catalogue is transmitted to the central computer unit where the host administrator incorporates it into a global component association database including component association catalogues provided by a plurality of component suppliers/manufactures. The host administrator incorporates all the component information to provide a comprehensive catalogue listing supplier component groups, the components within each group and the compatibility groups for those components. An example of the layout of the global database is shown in Table 3.

TABLE 3
Global Component Association Database

| Supplier Component | | Compatibility | Compatibility Group |
|---|---|---|---|
| Group | Part No. | Group | Members |
| Supplier X Oil Filters | X-OF-1 | X-CG-1 | MV-A, MV-B |
| | X-OF-2 | X-CG-2 | MV-C |
| Supplier Y Oil Filters | Y-OF-1 | Y-CG-1 | MV-A, |
| | Y-OF-2 | Y-CG-2 | MV-C, MV-D |
| Supplier X Head Gaskets | X-HG-1 | X-CG-3 | MV-A |
| | X-HG-2 | X-CG-4 | MV-B, MV-C |

As can be seen from Table 3, not all component suppliers will necessarily create the same compatibility groups for the same type of part. This will be due to differences in the manufacture of different parts.

In order to keep the database current, the host administrator will periodically, e.g. monthly, collate all information on new motor vehicles into a directory of new and modified product identifiers and transmit this directory to the supplier interfaces. The suppliers can then choose to deal with these new vehicles in one of three ways. Firstly, the supplier may add a new vehicle to an existing compatibility group. Secondly, the supplier may create a new compatibility group for one or more of the new vehicles and then associate that compatibility group with a specific component within the component group. Thirdly the supplier can choose to leave a vehicle as unassigned to any compatibility group within that component group by placing the vehicle identity in an unassigned directory. The process is repeated for all the component groups of the supplier.

By only allowing the above three methods for updating data it is not possible for a supplier to ignore new vehicle data. Therefore the database is maintained in an accurate and importantly in a searchable form because a search for a particular vehicle association within a component group will always return a result, even if that result is that the vehicle has no part associated with it within that component group.

The software of the present system can also be used by the supplier using the same drag and drop techniques to create new component groups and assign new components to existing component groups in a similar manner as for updating the vehicle information described above. The software of the invention is designed to integrate with the existing inventory control system of the supplier via a regular synchronisation interface.

One of the key advantages of the present invention is the benefit it provides to parts distributors in the form of a searchable database of component compatibilities across a range of component suppliers, with little interpretative skill required. Distributors can access the database 12 (FIG. 1) to download the integrated component catalogue to a distributor interface 15, 16. The distributor can then search the locally stored catalogue to ascertain what particular parts are compatible with certain motor vehicles in the manner described above, selecting from a drop down box of product identifiers. Furthermore the catalogue can be incorporated into the distributor's existing sales and accounting software to provide a total business management system, or with on-line catalogues and internet retailing.

The system of the invention also has facility to export the finished relationship data in a variety of formats to allow for mass distribution and application, including import into graphics packages for printed catalogue creation, web search application, multi-media CD creation or digital catalogue equivalent.

Further features of the invention will be apparent to the skilled reader. For example the database may further contain associations between component groups and/or compatible associations between components within different component groups, such as where certain components from one component group are only compatible with members of a compatibility group when used with a specific component from a separate component group. This aspect of the invention has particular application in the computer peripherals industry.

The database may also store additional component information, for example images, sound files, the cost of a component, a component's dimensions, current stock levels etc. as well as additional information on the products in the compatibility groups such as the full make and model of a motor vehicle, its engine type and body type.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be within the competence of those skilled in the art are therefore intended to be embraced therein.

1. In a computer database adapted for use by a product component supplier, a method of cataloguing components provided by said supplier and compatibility of said components with a plurality of products, including the steps of:
creating and modifying data relating to components specific to that supplier, said data including component identifiers for said components provided by said supplier,
creating and modifying a plurality of component groups, each component group containing component identifiers for one or more of said supplier's components of similar type,
creating and modifying one or more compatibility groups independently within each said components group,
creating and modifying associations between component identifiers and compatibility groups,
receiving product identifiers created by an external source and assigning each product identifier to a compatibility group within each component group, such that each compatibility group includes one or more product identifiers representing products with similar compatibilities within the respective components groups, and
providing a search tool whereby said database is queried by product identifier and component group to return one or more component identifiers compatible with the product represented by the product identifier.

2. In a computer database adapted for use by an administrator and multiple product component suppliers, a method of cataloguing components provided by said multiple suppliers and compatibility of said components with a plurality of products, including the steps of:
providing each said supplier with access to a portion of data relating to components specific to that supplier, said data including component identifiers for said components provided by said supplier,
providing each said supplier with tools for creating and modifying a plurality of component groups, each component group containing component identifiers for one or more of said suppliers components of similar type,
creating product identifiers relating to products, and exporting said created product identifiers to said multiple suppliers,
providing each said supplier with tools for creating and modifying one or more compatibility groups independently within each said components group and for creating and modifying associations between component identifiers and compatibility groups,
said suppliers receiving said exported product identifiers and assigning each product to a compatibility group within each component group, such that each compatibility group includes one or more product identifiers representing products with similar compatibilities within the respective components groups,
said suppliers exporting said data portion as modified to said administrator,
consolidating said data portions received from said suppliers into said database, and
providing a search tool whereby said database is queried by product identifier and component group to return one or more component identifiers compatible with the product represented by the product identifier.

3. A method according to claim 2 wherein said step of assigning a product to a compatibility group comprises assigning the product to an existing compatibility group, assigning the product to a new compatibility group or assigning the product to an unassigned compatibility group.

4. A database system for cataloguing components provided by a product component supplier and compatibility of said components with a plurality of products, including:
a computer processor,
a database readable by said processor,
component and product data stored in said database, said data including a plurality of component identifiers divided into one or more component groups,
each component group including one or more compatibility groups containing product identifiers, and associations between said component identifiers and a compatibility group, and
a search tool queried by component identifier to return one or more product identifiers compatible with the component represented by the component identifier.

5. A database system according to claim 4 wherein said component data includes data relating to components from multiple component suppliers.

6. A database system according to claim 5 further including multiple supplier interfaces each allowing access to a part of the data relating to the components of the respective supplier, said supplier interfaces including tools for creating and modifying one or more compatibility groups independently within each said components group, for creating and modifying associations between component identifiers and compatibility groups, and for receiving exported product identifiers and assigning each product to a compatibility group within each component group, such that each compatibility group includes one or more product identifiers representing products with similar compatibilities within the respective components groups.

7. A method according to claim 1 wherein said components are vehicle components and said product identifiers are vehicle details.

8. A method according to claim 2 wherein said components are vehicle components and said product identifiers are vehicle details.

9. A database system according to claim 4 wherein said components are vehicle components and said product identifiers are vehicle details.
